(19) United States
(12) Patent Application Publication
(10) Pub. No.: US 2005/0177255 A1
(43) Pub. Date: Aug. 11, 2005

(54) System and method for score keeping in a game of golf and a position coded paper therefore

(76) Inventors: Bengt Lundberg, Bromma (SE); Fredric Belin, Djursholm (SE); Magnus Granberg, Eskilstuna (SE)

Correspondence Address: NIXON & VANDERHYE, PC, 901 NORTH GLEBE ROAD, 11TH FLOOR, ARLINGTON, VA, 22203, US

(21) Appl. No.: 10/515,119

(22) PCT Filed: Jun. 2, 2003
(86) PCT No.: PCT/SE03/00892

(30) Foreign Application Priority Data
Jun. 3, 2002 (SE) 0201674-9

(51) Int. Cl. G06F 155/00

(52) U.S. Cl. 700/91; 473/131

(57) ABSTRACT

When scoring a game of golf, a player is equipped with a course guide printed on a position-coded paper provided with coordinates readable by an electronic device. The player indicates/marks on the course guide each stroke he makes by marking on the paper the position of his ball after each stroke using the electronic device. After a completed game the data regarding the golf game registered by the electronic device is processed in a computer and output in a format preferred by the player. The player can also indicate the club he uses for each stroke as a separate input in the course guide printed on a position coded paper. Hereby, the player can receive statistics of interest after completing the golf game.

### TECHNICAL FIELD

The present invention relates to a device for golf, and in particular to a device for score keeping and other data related to a golf game. The present invention also relates to a method and a system for use in conjunction with the device. The invention further relates to a method and a system for processing and presenting information data recorded by such a device.

### BACKGROUND OF THE INVENTION AND PRIOR ART

During a game of golf each player is usually required to keep his/her score. The method by which the score is recorded can vary, but today the most predominant way is by means of paper and pen. However, other methods exist. For example the U.S. patent application Ser. No. 5,283,733 describes a computer network extending around all the holes of a golf course including a series of interconnected display terminals that can display the real time scores of all players on the course at any time. The terminals may also be equipped with printers for generating hard copies of scores. The terminals are further provided with transceivers for two-way radio communication with transceivers in portable player's units carried by each of the players.

Other portable computer devices for scoring a golf game are described in U.S. Pat. No. 4,910,677, U.S. Pat. No. 5,127,044 and U.S. Pat. No. 5,095,430. The portable computer devices are however associated with a number of disadvantages. First and foremost they are quite expensive. In addition they have an electronic display, which makes the device cumbersome to carry also the electronic display is sensitive to water, which make such devices unsuitable to use in rain. Also, it is usually difficult to see the screen in sharp sunlight.

As a supplement to both manual (paper and pen) and computerized scoring devices, most golf courses have a course guide. The course guide is a detailed view of each hole on the golf course usually giving the player extensive information regarding distances between different locations and in particular to the green on the course. Other useful information may also be printed in the course guide. The course guide can be printed as a small leaflet where each page in the leaflet depicts one hole.

Further, the U.S. Pat. No. 4,666,157, discloses a booklet whereby a golf player is able to note data related to a golf game on a layout diagram of a golf hole. The data collected can later be transferred into a computer for storage therein. However, no means for performing the transferal from the booklet to a computer is shown, nor does the device in U.S. Pat. No. 4,666,157 provide an easy to use input and output interface for a user of the device when digitally recording and evaluating a game of golf.

### SUMMARY

It is an object of the present invention to provide a device for golf scoring that not suffers from the above disadvantages and which is easy to carry along and use, and which in comparison with a computer device is inexpensive, is insensitive to weather and has a robust design.

It is an additional object of the present invention to provide a device designed to work in close connection to a computer system, and which can provide interesting statistics for the player scoring a golf game with easy access. The present invention also extends to a method for electronically recording and displaying data relating to one or several games of golf.

These objects and others are obtained by the present invention as set out in the appended claims. Hence, a golf player scoring a game of golf is equipped with a course guide printed on a position coded paper provided with coordinates readable by an electronic device. The player indicates/marks on the course guide each stroke he makes by marking on the paper having such a position coded pattern the position of his ball after each stroke using the electronic device. After a completed game the data regarding the golf game registered by the electronic device is processed in a computer and output in a format preferred by the player.

In a preferred embodiment the player can also indicate the club he uses for each stroke as a separate input in the course guide printed on a position-coded paper. Hereby he can, after proper computer processing receive statistics of interest after completing the golf game.

In accordance with another preferred embodiment of the invention the electronically recorded data are stored on a web server remotely accessible by a registered user of a web service providing easy to access golf game statistics stored and processed on the web server.

### BRIEF DESCRIPTION OF THE DRAWINGS

The present invention will now be described in more detail by way of non-limiting examples and with reference to the accompanying drawings, in which:

FIG. 1 is a general view of a system for computerized scoring of a golf game including calculation and display of score and associated statistics.

FIG. 2 is a view of a page in a golf course guide printed on a position-coded paper for use together with an electronic device.

FIG. 3 is a flow chart illustrating different steps carried out when using the system as depicted in FIG. 1.

### DESCRIPTION OF PREFERRED EMBODIMENTS

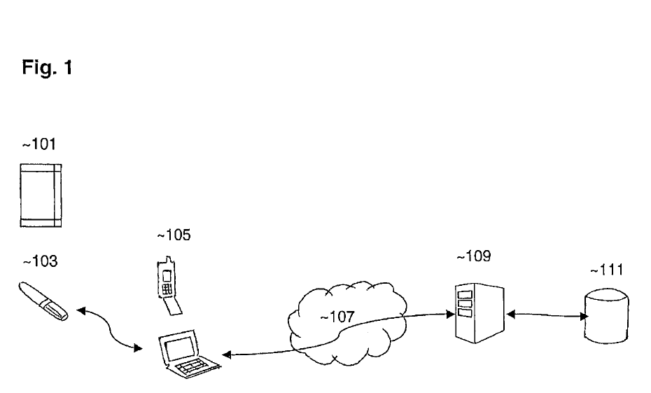

In FIG. 1, a general view of a system for computerized scoring of a golf game including calculation and display of a score and associated statistics is shown. The system comprises an electronic data recording device, in this case a golf scorecard/course guide printed on a position-coded paper 101 and an associated electronic device 103 for use together with the printed scorecard/course guide. The electronic device and the position-coded paper can for example be the electronic pen and its associated paper developed by Anoto AB, Sweden.

The data recorded by the electronic device and stored therein can at a suitable time be transferred to a local computer terminal 105 connected to the Internet or some other network 107. Preferably data recorded during a game of golf is transmitted after a completed game, but may also be transmitted at predetermined times, such as after completion of each hole or in real time as new data is recorded. Via the network 107 the terminal 105 can access a central computer server 109 loaded with software for processing the collected data. In a preferred embodiment the server 109 is connected to a database 111 loaded with information relating to different golf courses. The central computer server 109 can in it self also be a web server designed for remote access by registered users.

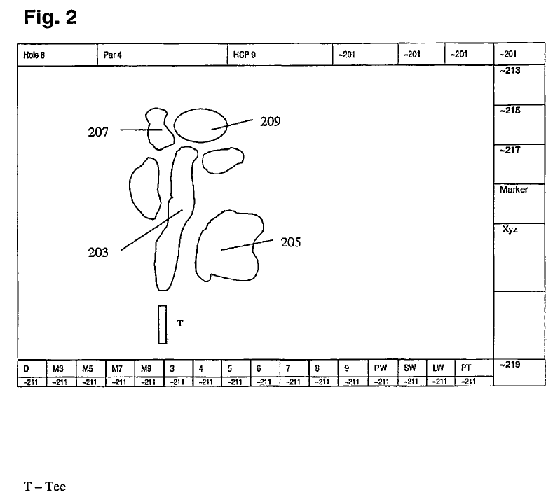

In FIG. 2, a view of a page of the position-coded paper 101 having a golf course layout printed thereon is shown. The page shows the golf hole layout including i.a. distance from different tees 201, fairway 203, water 205, bunkers/sand traps 207, and green 209. The page also preferably comprises a number of boxes for current club choice 211, total strokes for the hole 213, penalty strokes 215, number of puts 217, and box for “hole completed” 219, which may be used for transmitting data after each hole completed. Each hole is however preferably printed on a paper having a different position code whereby different holes can be kept separated. Additionally, the page may comprise boxes for changing the latest stroke in case an erroneous mark was made on the page. Also a box for dropping a ball may be provided. In yet another preferred embodiment the page, in addition to regular club choices 211, comprise boxes for indicating pitches/chips with less than a full swing in order to preserve data relating to length of a particular club.

In a preferred embodiment all holes of a golf course are printed in a leaflet. The leaflet then preferably also comprise a position coded field unique for each course that can be ticked when starting a game of golf. By providing such a code, the same position code can be reused for every separate golf course, which is an advantage. Additionally, each page of such a leaflet may comprise one or several boxes, where the player can electronically enter the score of another player playing the same hole. This can for example be used when the player is playing a tournament and marks the score of another player in that tournament.

An electronic device senses the golf players input for each stroke. The input can include club choice for each stroke as indicated in the boxes 211, e.g. by ticking one of the boxes. The current position of the ball is marked with an “X” or an “O” (see below), on the golf hole layout as the game goes along, for example the location on fairway and location on green. Before completing scoring the hole, the player will preferably also mark the boxes 213, 215 and 217 with the number of strokes made in each category.

After completion of a game of golf the player preferably ticks a box indicating the end of the round.

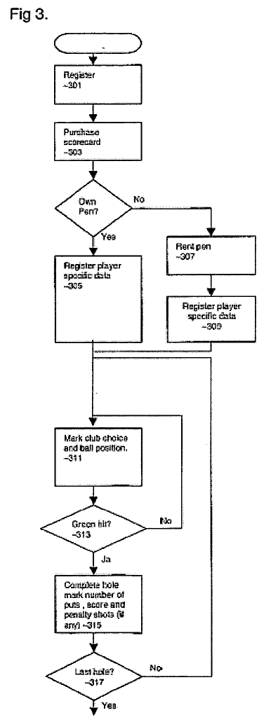

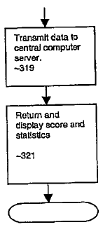

In FIG. 3, a flowchart illustrating one preferred embodiment according to which the scoring card as described herein can be used to benefit a golf player. First, when a player arrives at the golf course he will register, step 301. Next, in a step 303 he will purchase a score card of the type described above in conjunction with FIG. 2, i.e. a complete course guide in a leaflet format printed on a position coded paper designed form recording by an electronic recording device, and which course guide preferably includes fields (boxes) for additional stroke information such as club used etc.

If the player owns an electronic device capable of working together with the particular paper on which the scorecard is printed he may use that. For example, if the player owns a digital pen hosing a small digital camera taking photos at a high rate when moved over a particular position coded paper and having a processor with an associated memory storing the different movements made over the position coded he may use that. For example he may own the digital pen Chatpen CHA-30 manufactured by Sony Ericsson AB Sweden. In that case he can register some player specific data for use later, step 305. For example, he may register name exact handicap etc.

If the player does not bring a suitable electronic device he can rent one at the golf course, step 307. He will preferably also register his name, handicap, tee, etc, step 309. The golf player then in a presently preferred embodiment starts registering a golf game by ticking a box unique for the particular golf course he will be playing. For each hole and after each stroke the player will then, using the electronic device and the position-coded scorecard/course guide, preferably marks his club choice and the ball position, step 311.

After each stroke the player will indicate which club he used, e.g. a driver and the ball position. This will be repeated for each stroke the player makes. The player can indicate the ball position for example by marking an “X” or “O” at the corresponding location.

If the player hits the green he will preferably stop this process in a step 313 and continue to a step 315. In step 315 he puts the ball into the hole indicates the number of puts used, his score for the hole, and the number of penalty strokes. Thereupon he proceeds to the next hole in a step 317 where the procedural steps 311, 313 and 315 are repeated.

If the last hole played was the last hole on the course the procedure continuous to a step 319. In step 319 the data recorded and stored by the electronic device is transmitted to a central computer, for example via a local computer and a fixed network or over a mobile network using a mobile device. The central computer server receives the data recorded by the electronic device and processes the data. The central computer server then returns the processed data, e.g. the score and some relevant statistics, for output at a suitable location and in a suitable format, e.g. a computer with an associated printer located at the golf club, via a mobile message service, e.g. SMS, MMS, or some Web service, step 321.

Below the function of the central computer server 109 loaded with software for processing the data input as collected by a player is described in more detail. For each played round of golf input to the central computer server, the server preferably receives information regarding the name of the player, type (male/female), exact handicap, the course played, and the tee used. In the case when the player has his own electronic device to record the golf game with, that device can be registered centrally, and only the course need to be input, unless some of the data has changed since the last time. As an example the exact handicap may have changed.

The central computer server is preferably also fed with information regarding the present position of the tees for each particular hole of a golf course. The tee information can for example be input by personnel of the golf club.

When the player has completed his game, he will transfer the data recorded. The data transmission can be initiated in a number of different ways. In one preferred embodiment, the player ticks a particular box when close to a local computer. The tick in the box signals to the electronic device to establish a Bluetooth connection with the local computer and transmit the data. The local computer then forwards the data to the central computer server. Also, the data may be transmitted using a wireless connection continuously during the game. Other ways of transmitting the data are of course also possible.

Then, preferably via a look-up server the data is directed to a program receiving the recorded data of the golf round. Thus, the program will receive data relating to Name, player type, exact handicap, golf course identity and, tee, and for each hole:
the coordinate of the ball after each stroke (X; Y)
the club used for each stroke
the number of penalty strokes, if any (default=0)
the number of puts
total score

Different electronic recording devices may have different ways of storing information relating to a particular symbol. Below it is assumed that the electronic device is a Chatpen CHA-30, which stores a symbol, such as “X” and “O” using so-called PenStrokes. Each PenStroke results in a number of pairs of X and Y coordinates and an associated color code. In the now described embodiment the color represents the club chosen by the player.

The X; Y coordinates indicates where on the position coded paper the device has been positioned, kept down against the paper and then lifted. Thus, an “X” results in two PenStrokes, whereas an “O” results in one pen stroke. If an “X” is indicated the program finds the intersection between the two PenStrokes, and this coordinate will represent the ball position. If an “O” is indicated the program will calculate the center of the circle and this coordinate will indicate the position of the ball.

Next, the program will convert the X and Y coordinates obtained into coordinates of an image stored in a database, see below. Using this information and information of the total area represented on the scorecard, the difference between two pairs of X; Y coordinates can be transformed into a distance in e.g. meters or yards. If the resolution of the position coded paper is higher than the pixel represented image stored in the database, more than one coordinate given by the pen will correspond to the same pixel in the data base image.

The database 111, where images of all holes of all golf courses supported by the central computer server are stored, can preferably have the following structure. The X and Y coordinates for all holes are read from a file. Preferably a pixel based image format is used, e.g. BMP; GIF etc. Each course part (fairway, bunker, green water, tree, etc, etc.) is given a unique color code in the image file. The image file will also comprise information relating to the position of the respective tees of each hole. The information of the image file is stored in the database. In a preferred embodiment, only the pixels having a neighboring pixel of a different color are stored. In this way the data in the database can be reduced significantly.

In an RGB (Red Green Blue) color code the following codes may be used for the different parts of the course:
Green=(0,255,0)
Water=(0,0,255)
Fairway=(0,128,0)
Bunker=(128,128,0)
Out of bounds (192, 192,192) Etc., etc.

When the central computer server 109 has calculated the ball position into pixel coordinates of the image file stored in the data base 111, the computer program can determine in what part of the course (fairway, bunker etc) the ball has been marked.

After having processed all data for all players playing the same game or a player recording many rounds of golf, the central computer server can output a significant amount of statistics relevant to the game. This statistics and data include:
Average drive (all, per course, per player)
Longest drive (all, per course, per player)
Number of puts (per player, per hole, per course)
Number of fairway hits (per player, per hole, per course)
Statistics regarding frequency of club used
Number of green hits (per player per hole, per course)
Number of water and bunker hits (per hole, per course)
Average score (per course, per hole)
Average deviation from exact handicap
Score

The central computer server is in accordance with one preferred embodiment a web server accessible via the Internet. The web server may store and present golf data recorded as described herein to a registered user connected to the web server. In this way a golf player may subscribe to additional services provided by the web server, such as statistics over long time periods.

Using the device system and method as described herein interesting statistics regarding a golf game can be recorded and presented in a cost efficient and easy to use manner.

1. A system for recording and displaying data relating to a game of golf the system comprising:
a data recording means including a golf course layout printed on a position coded paper and art associated electronic device for marking and recording positions on said position coded paper
central computer server connectable to the data recording means for processing data recorded by said data recording means, and
a display unit connectable to the central computer server for display output data from the central computer server.

2. A system according to claim 1, wherein the central computer server is associated with a database storing image information relevant for each hole of each course supported by the central computer server.

3. A system according to claim 1, wherein the position coded paper having the golf course layout printed thereon further comprises a field for marking the club used for each stroke.

4. A method of recording data relating to a game of golf comprising the step of: noting on a position coded paper having the course layout printed thereon using an associated electronic device wherein said data is recorded.

5. The meted according to claim 4 further comprising the step of: transmitting the information from the electronic device to a central computer server wherein the recorded data is processed.

6. The method according to claim 5 further comprising the step of: displaying data processed in the central computer server in a user configurable format.

7. The method according to claim 5, wherein the step of processing recorded data comprises comparing coordinates recorded on the position coded paper with an image stored in a database for obtaining the distance of each golf shot and for obtaining which part of the golf course the ball is positioned, e.g. on the fairway.

8. The method according to claim 4, wherein the data recorded comprises the ball position after each stroke played from outside the green and/or the club used for each stroke played from outside the green.

9. A position coded paper having a golf course layout printed thereon, wherein the position code forms a pattern designed to be read by an electronic device.

10. A paper according to claim 9, wherein each hole of the course is printed on a page in a leaflet.

11. A paper according to claim 9, wherein the coding pattern is unique for each hole of a golf course.

12. A paper according to claim 9, wherein each page with a hole printed thereon additionally comprise boxes representing a number of different golf clubs.

13. A paper according to claim 9, wherein each page with a hole printed thereon additionally comprise boxes representing a number of shots for that particular hole.

14. A paper according to claim 9, wherein each page with a hole printed thereon additionally comprise a box for changing the latest recorded input.

15. A paper according to claim 9, wherein each page with a hole printed thereon additionally comprise boxes representing a number of puts for that particular hole.

16. A paper according to claim 9, wherein each page with a hole printed thereon additionally comprise boxes for electronically marking the score of another player.

17. A leaflet comprising a number of position coded pages having a complete golf course layout printed thereon, wherein the position code forms a pattern designed to be read by an electronic device.

18. A leaflet according to claim 17, wherein said code pattern uniquely identifies said golf course.

19. A leaflet according to claim 17 further comprising a separate code pattern filed uniquely identifying said golf course.

20. A computer server remotely accessible and designed to process data related to a game of golf, the server additionally comprising:
means for receiving golf data recorded electronically using an electronic device recording data using a position coded paper.

21. A computer server according to claim 20, wherein said remote access is an Internet access.

22. A computer server according to claim 20, further comprising a memory, said memory forming a database for storing the golf data.
